(19) United States
(12) Patent Application Publication
(10) Pub. No.: US 2009/0190916 A1
(43) Pub. Date: Jul. 30, 2009

(54) Portable Handheld Video Imaging Camera

(75) Inventor: Robert W. Sharp, Woodville, AL (US)

Correspondence Address: LANIER FORD SHAVER & PAYNE P.C., P O BOX 2087, HUNTSVILLE, AL, 35804-2087, US

(73) Assignee: Southern Vision Systems, Inc., Madison, AL (US)

(21) Appl. No.: 12/020,985

(22) Filed: Jan. 28, 2008

(51) Int. Cl. G03B 17/00; H04N 5/225

(52) U.S. Cl. 396/425; 348/372; 348/E05.024

(57) ABSTRACT

A portable, handheld battery-operated camera system is claimed. The camera is positioned atop a handle with a grip and comprises a finger-operated trigger for starting or stopping camera operation. The handle comprises a substantially hollow interior and a bottom concavity which detachably receives a rechargeable battery for powering the camera.

### FIELD OF THE INVENTION

The present invention relates generally to the field of video imaging devices, and specifically to a portable, handheld battery-operated video imaging camera.

### BACKGROUND AND SUMMARY OF THE INVENTION

Video imaging cameras, including analog and digital, and high-speed and low-speed cameras, are increasingly being made in portable, hand-held forms. Digital cameras using rectangular arrays of photo-detector picture elements (pixels) are replacing film cameras in the fields of motion capture, machine diagnostics, bio-analysis, ordnance characterization, and missile development. A camera assembly in accordance with an embodiment of the present disclosure comprises a hand-held, rechargeable battery-operated, portable camera. The camera is disposed within a housing connected to a handle, wherein the handle comprises a grip portion with a trigger switch for initiating a recording session. The handle further comprises a bottom concavity for receiving a rechargeable battery which provides electrical power to the camera assembly. A power controller inside a top portion of the handle conditions the power received from the battery and delivers it to the camera. The power controller also generates a trigger signal that starts the camera recording upon depression of the trigger switch, and stops the camera recording when the trigger is released. The battery in the handle provides a counter-balance to the operator and serves to steady the camera when it is in use.

### DESCRIPTION OF THE DRAWINGS

FIG. 1 is a front perspective view of an embodiment of a camera assembly in accordance with the present disclosure.

FIG. 2 is a left side view of an embodiment of a camera assembly in accordance with the present disclosure, in which the viewfinder is foldable.

FIG. 3 is a left side view of an embodiment of the camera assembly in accordance with the present disclosure, in which the viewfinder is fixed.

FIG. 4 is an exploded perspective view of an embodiment of the camera assembly handle in accordance with the present disclosure.

FIG. 5 is a rear view of an embodiment of the camera assembly in accordance with the present disclosure.

FIG. 6 is a rear cross sectional view of the camera assembly of FIG. 5.

FIG. 7 is a side cross sectional view of the camera assembly of FIG. 5.

FIG. 8 is a block diagram illustration of an embodiment of the camera assembly according to the present disclosure.

FIG. 9 is a block diagram illustrating an exemplary power controller of the system depicted in FIG. 1.

FIG. 10 is a flowchart depicting exemplary architecture and functionality of the system depicted in FIG. 1.

FIG. 11 is a block diagram illustration of an embodiment of the camera assembly wherein an adapter is disposed between the handle and the camera housing.

Repeat use of reference characters throughout the present specification and appended drawings is intended to represent the same or analogous features or elements of the invention.

### DETAILED DESCRIPTION

The present invention and its advantages are best understood by referring to the drawings. The elements of the drawings are not necessarily to scale, emphasis instead being placed upon clearly illustrating the principles of the invention.

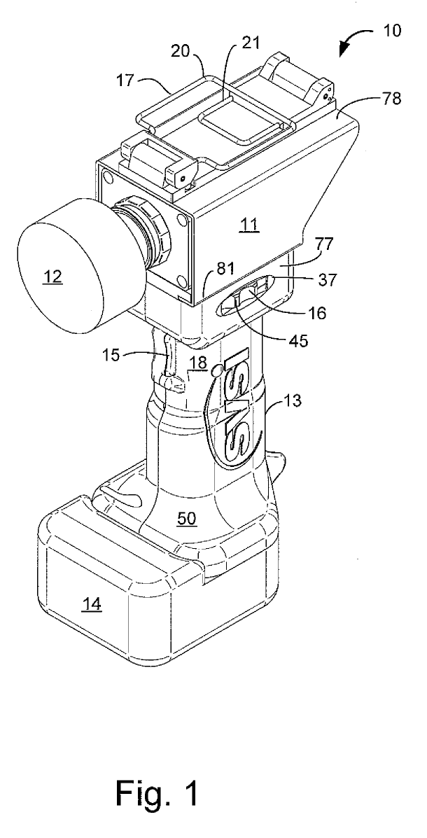

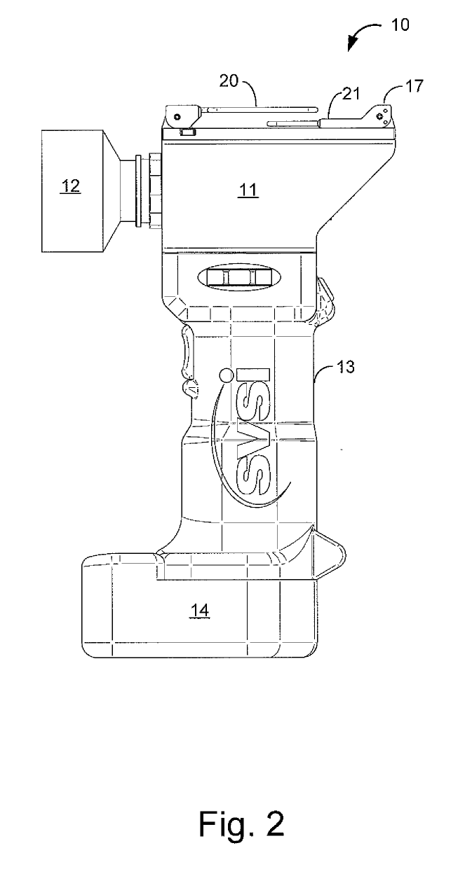

FIG. 1 illustrates one exemplary embodiment of a camera assembly 10. A camera body 11 houses an optical sensor (not illustrated) and camera electronics (not illustrated). In the illustrated embodiment of the invention, the camera body 11 is a charge coupled device (CCD) camera, though other cameras may be used in other embodiments of the invention. A camera lens 12 receives images, and may be a standard C-mount compatible lens. A substantially vertical handle 13 supports the camera assembly 10 in an upright position. The handle 13 connects to the bottom side 81 camera body 11 by a mounting screw 41 (FIG. 2) turned by a thumb wheel 16, the outer edge of which thumb wheel 16 protrudes through an opening 37 on left side 77 of the upper portion 18 of the handle. The upper portion 18 of the handle 13 is contoured to fit the user's hand (not illustrated) for a comfortable grip.

A user (not illustrated) depresses trigger 15 with a finger (not illustrated) to start the camera 11 recording. Releasing the trigger 15 stops the recording. In an alternative embodiment, depressing the trigger 15 stops the recording and releasing the trigger starts the recording.

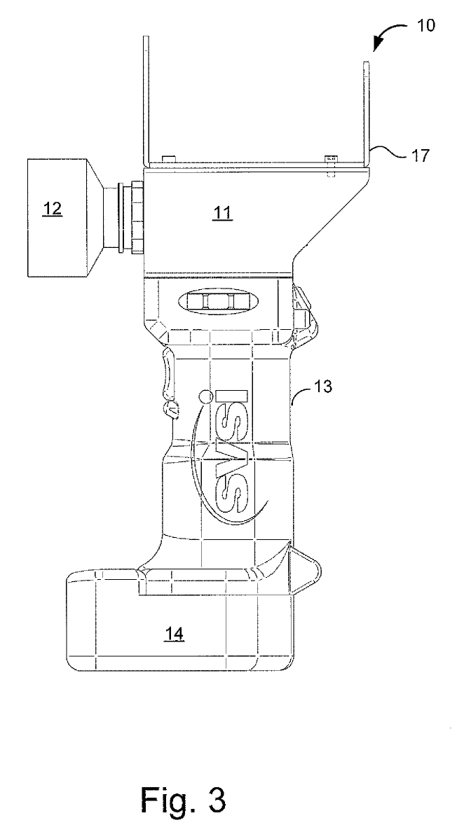

A viewfinder 17 (illustrated in undeployed position in FIG. 1) is used for aligning the camera assembly 10 to its subject (not illustrated). The viewfinder 17 may be of the type illustrated in FIG. 1, wherein a front viewfinder portion 20 and a rear viewfinder portion 21 are both foldable against the top 78 of the camera body 11 when not in use, as further illustrated in FIG. 2. In other embodiments, such as the embodiment illustrated in FIG. 3, the viewfinder 17 may be fixed (i.e., not foldable). In still other embodiments, the viewfinder 17 may be replaced with an LCD display (not illustrated).

Referring to FIG. 1, a rechargeable battery (not illustrated) housed inside a battery 14 provides power for the camera assembly 10. In the illustrated embodiment, the battery 14 is a Hitachi EB1214S model battery that supplies 12V DC power at a minimum of 500 mA of current.

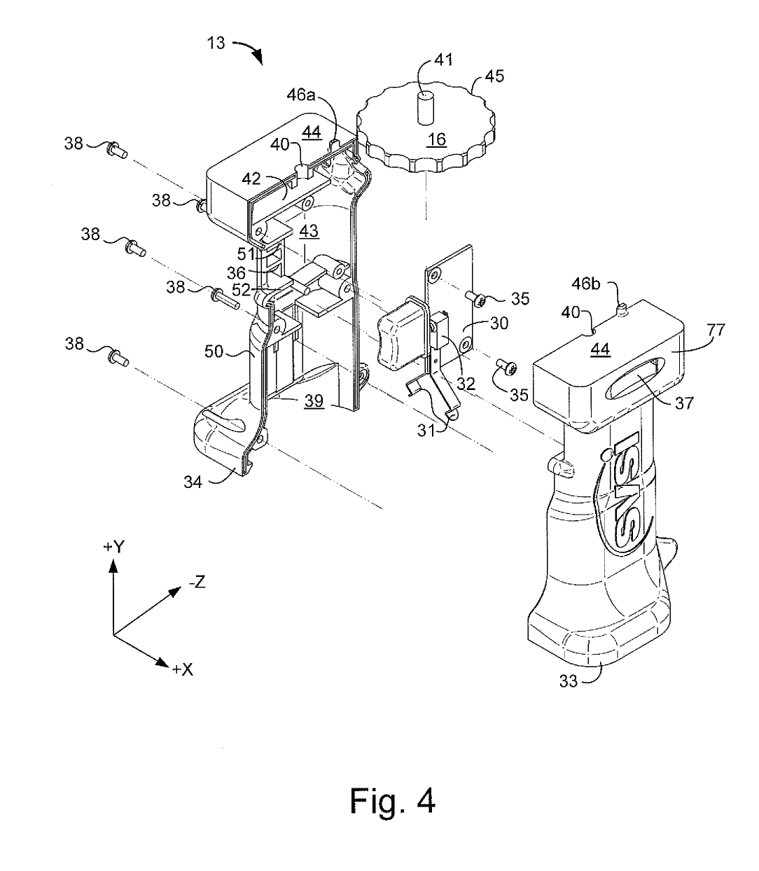

FIG. 4 is an exploded view of the interior of the handle 13 of the camera assembly 10. The handle 13 is comprised of two side portions 33 and 34 which are joined together by a plurality of screws 38. The side portions 33 and 34 are substantially hollow for receiving internal components such as the battery 14 (FIG. 1), the thumb wheel 16, and a power controller 30. The side portions 33 and 34 may be fabricated from molded hard plastic, composite material, or any suitable rigid material. Although FIG. 4 illustrates the interior of only one portion 34 of the two side portions 33 and 34, the two side portions are substantially similar and generally mirror-imaged to one another.

The thumb wheel 16 turns the mounting screw 41 that makes the physical connection between the handle 13 and the camera body 11 (FIG. 1). When the side portions 33 and 34 are joined together, the thumb wheel 16 fits into a recess 42 on the side portions 33 and 34, and an outer edge 45 of the wheel 16 protrudes through the opening 37, as shown in FIG. 1. Although FIG. 4 illustrates only the opening 37 on side portion 33 of the handle 13, side portion 34 comprises an identical opening, such that the wheel 16 protrudes through openings 37 on both sides of the handle 13.

Referring to FIG. 4, an aperture 40 is a hole in the top surface 44 of the handle 13 created by the joining of portions 33 and 34. The mounting screw 41 protrudes through the aperture 40 and threads into an opening (not illustrated) on the lower side 81 (FIG. 1) of the camera body 11 to secure the camera body 11 to the handle 13.

The trigger 15 is held in position by a trigger alignment shelf 36, which is a raised portion of the interiors of handle portions 33 and 34. The trigger alignment shelf 36 is bounded by an upper stop 51 and a lower stop 52, as illustrated in FIG. 4. When the handle portions 33 and 34 are joined, the alignment shelf 36 “sandwiches” the trigger 15 to prevent the trigger 15 from dislocating in the ±x direction (see FIG. 4), and the upper and lower stops 51 and 52 prevent it from dislocating in the ±y direction (see FIG. 4). Depressing the trigger 15 activates a switch 32, which allows a trigger signal generated in the power controller 30 to be transmitted to the camera assembly 10 to start the recording process.

The power controller 30 comprises a circuit hoard that fits into a recess 43 in the handle portions 33 and 34 and is secured via a plurality of screws 35. The power controller 30 further comprises power filtering circuitry (not shown) and a synch pulse generator (not shown). A pair of contacts 31 protruding from the power controller 30 makes electrical contact with contacts on the battery (not illustrated). The power controller 30 receives 12 VDC power from the battery 14 and filters and conditions the power received from the battery 14 and then provides the power to the camera body 11.

As illustrated in FIG. 4, a bottom concavity 39 is defined by the flared bottom portion 50 of handle portions 33 and 34 for receiving the battery 14 (FIG. 1). The bottom concavity 39 detachably receives the battery 14. The contacts 31 extend from the power controller 30 into the bottom concavity 39 for connection to the battery contacts (not illustrated).

Right side notch portion 46a on side portion 34 forms a notch (not shown) when joined with left side notch portion 46b on side portion 33. The notch comprised of 46a and 46b fits into a mating hole on the bottom of the camera body 11 (FIG. 1) to prevent the camera body 11 from rotating about the mounting screw 41 when installed.

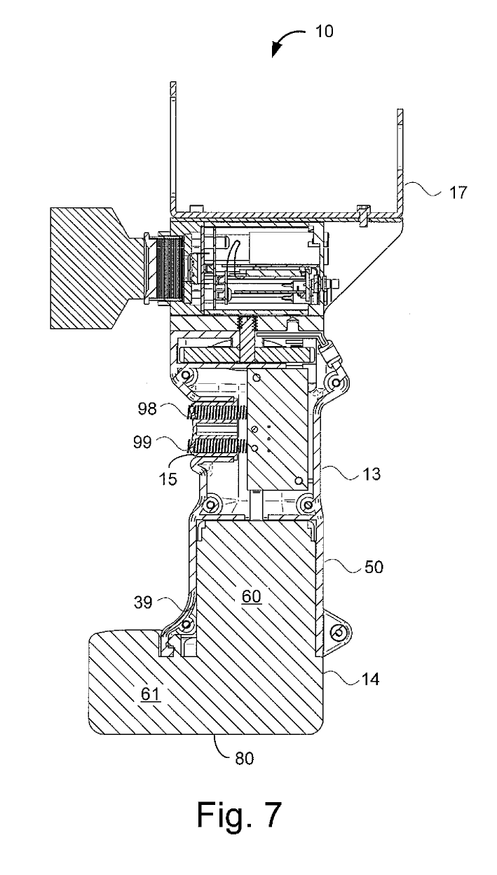

Referring to FIG. 4, with further reference to FIG. 7, when a user (not illustrated) depresses the finger-operated trigger 15, the trigger 15 moves in the −z direction sufficiently to cause the switch 32 to close, sending power from the battery (not illustrated) to the power controller 30, and then to the camera body 11.

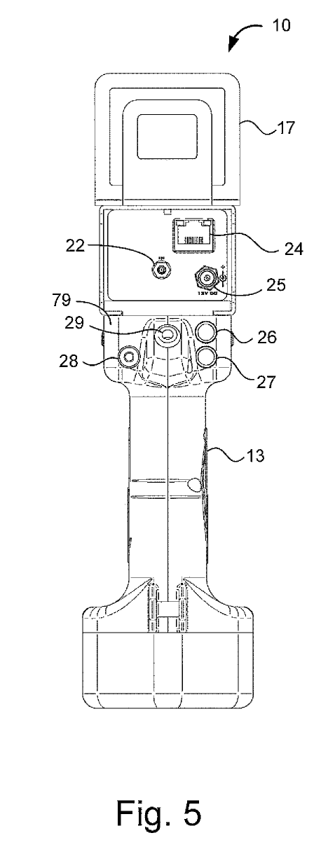

FIG. 5 is a rear view of the camera assembly 10 according to an embodiment of the present disclosure. Two (2) light-emitting diodes (LEDs) 26 and 27 are disposed on the rear side 79 of the handle 13. In the illustrated embodiment, a green LED 27 activates when the camera assembly 10 is powered on to provide a visual indication to the user (not illustrated) that the camera assembly 10 is powered. The camera assembly 10 powers on (and the green LED 27 activates), as soon as a battery 14 is installed into the handle 13. The green LED 27 will remain activated for as long as the voltage received by the power controller 30 is within a predetermined range for optimal operation of the camera assembly 10. For example, a particular camera may require 10V for operation, and the 12V battery 14 will eventually drop below 10V. In such an event, the power controller 30 shuts off power to the camera and the green LED 27 deactivates as a visual indication that the camera is not powered.

In the embodiment illustrated in FIG. 5, a yellow LED 26 activates when the camera assembly 10 is recording to provide a visual indication to the user (not illustrated) that the camera assembly 10 is recording. In other embodiments (not illustrated), no yellow LED 26 is present, and the green LED 27 will change from a solid green (indicating power on to camera) to a blinking green when the camera is recording.

Referring to FIG. 5, port 24 provides an IEEE 802.3 Ethernet connection on the rear of the camera body 11. Port 24 is a gigabit Ethernet port in the illustrated embodiment, but in other embodiments may be any other suitable data interface, either analog or digital, such as a CamLink interface. A trigger input port 22 receives the trigger signal (not shown) from the power controller 30. A power input port 25 provides power to the camera body 11. A power output port 29 houses a power cord (not illustrated) that delivers power to the power input port 25. Remote activation port 28 provides a connection from the power controller 30 for remote activation of the camera by a computer (not illustrated). Remote activation of the camera assembly 10 may be used in lieu of manual depression of the trigger 15 to start and stop camera operation.

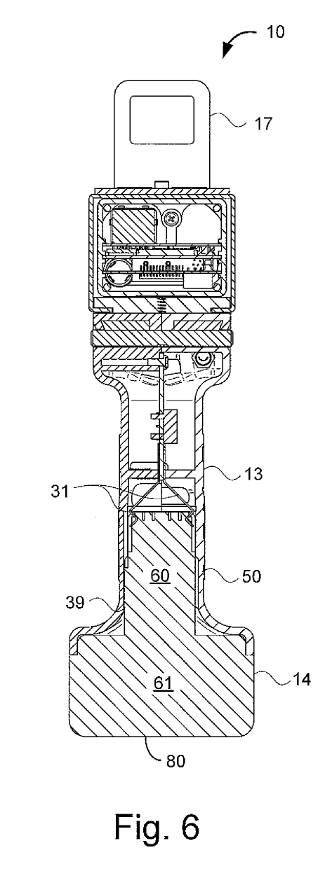

FIGS. 6 and 7 are cross-sectional views of one embodiment of the present disclosure illustrating the battery 14 inserted into the bottom concavity 39 of the handle 13 of the camera assembly 10. As illustrated, a top portion 60 of the battery 14 is enclosed in the bottom portion 50 of the handle 13. The battery 14 is detachably restrained within the handle 13 via a friction fit and a standard latch (not shown). The bottom portion 61 of the battery 14 is larger than the top portion 60. The size, shape, and weight of the battery 14 enables it to serve as a counter-balance such that it steadies the camera assembly 10 when it is in use.

The bottom surface 80 of the battery 14 is substantially flat, such that the camera can be supported in operable orientation (i.e., with the handle 13 oriented vertically) when set on a generally flat surface. A threaded tripod-mounting hole (not shown) on the bottom surface 80 of the battery 14 connects to a standard camera tripod (not shown), if desired. Two (2) springs 98 and 99 (FIG. 7) apply force against the trigger 15 from the inside of the handle 13 to maintain the trigger 15 in an outwardly-deployed orientation until it is depressed.

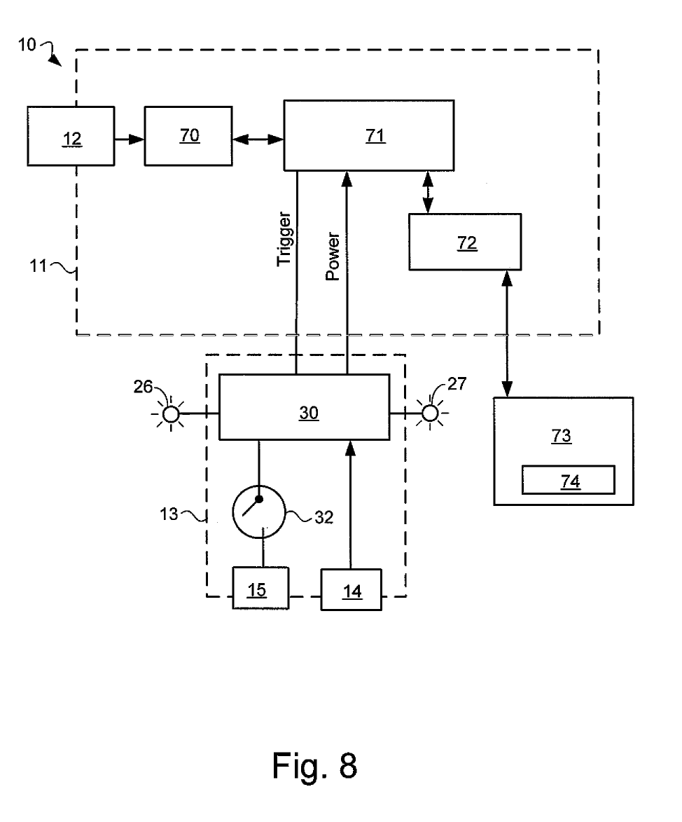

FIG. 8 is a block diagram of one embodiment of the camera assembly 10 of the present disclosure. The camera body 11 comprises an image sensor 70 that receives images (not illustrated) through the lens 12. A camera controller 71 contains processing components (not illustrated) for controlling camera operation. A standard digital interface 72 (e.g. USB, Firewire, Serial, Ethernet) interfaces with a remote host computer 73, which contains memory 74.

The handle 13 comprises the battery 14 and the trigger 15. Depression of the trigger 15 activates a switch 32, which causes a synch pulse generator (not shown) in the power controller 30 to send trigger signals to the camera controller 71 to start the recording process. Releasing the trigger 15 stops the recording process.

Power controller 30 further comprises power filtering circuitry (not shown) that prevents a short circuit that would damage the camera assembly 10. Power controller 30 further comprises circuitry (not shown) that shuts off power to the camera if the voltage received from the battery 14 falls outside of a predetermined range. This feature protects the camera from being subject to depleted voltage from the battery 14.

In operation of the camera assembly 10 according to one embodiment of the present disclosure, a user (not shown) installs the battery 14 into the handle 13. Once the battery 14 is installed, power from the battery 14 flows to the power controller 30, where it is conditioned and transmitted to the camera controller 71. Green LED 27 activates when the battery 14 is both installed and providing power within a predetermined voltage range.

Depression of the trigger 15 causes the switch 32 to close, and a pulse synch generator (not shown) within the power controller 30 generates a 200 hz pulse train which is sent to the camera controller 71 to start the recording process. Yellow LED 26 activates while the trigger 15 is depressed to server as a visual indicator that the camera is recording. The camera controller 71 receives image data (not illustrated) from the image sensor 70 and passes the image data in a frame buffered form to remote memory 74 or disk space within the remote host computer 73 The remote host computer 73 may be a laptop, PC, or any standard computer. When the trigger 15 is released, recording stops after a short delay of generally about a half a second.

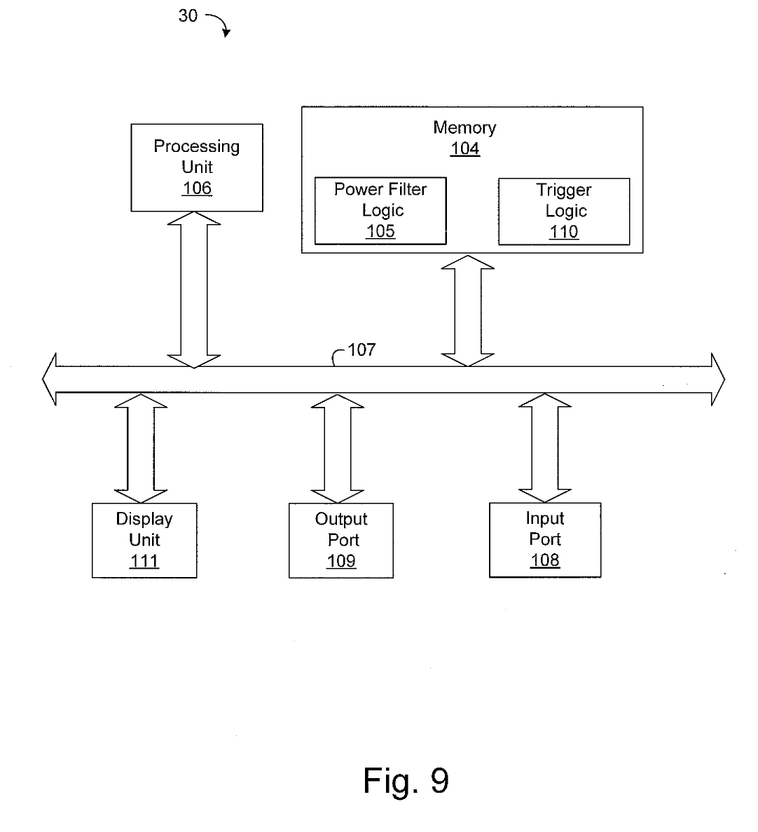

FIG. 9 depicts an exemplary power controller 30 of the present disclosure. The exemplary power controller 30 generally comprises a processing unit 106, an input port 108, and an output port 109. The power controller 30 further comprises power filter logic 105, which can be software, hardware, or a combination thereof. The power controller 30 further comprises trigger logic 110, which can be software, hardware, or a combination thereof. In the exemplary power controller 30, power filter logic 105 and trigger logic 110 are shown as stored in memory 104.

The processing unit 106 may be a digital processor or other type of circuitry configured to run the power filter logic 105 and trigger logic 110 by processing and executing the instructions of the power filter logic 105 and trigger logic 110. The processing unit 106 communicates to and drives the other elements within the power controller 30 via a local interface 107, which can include one or more buses.

In the exemplary power controller 30 of FIG. 9, the power filter logic 105 and trigger logic 110 are shown as being implemented in software and stored in the filter memory 104. However, the power filter logic 105 and trigger logic 110 may be implemented in hardware, software, or a combination of hardware and software in other embodiments.

When stored in filter memory 104, the power filter logic 105 and trigger logic 110 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The power filter logic 105 may perform a plurality of functions. As an example, the power filter logic 105 may control the conditioning of power received from the battery 14. The power filter logic may shut off power to the camera assembly 10 if the power from the battery 14 falls outside of a predetermined range. For example, if the battery 14 provides 12 VDC power, and the camera assembly 10 requires a minimum of 10 VDC power to operate, the power filter logic 105 shuts off power to the camera if the power from the battery 14 drops below 10 VDC. The power filter logic further may control power to the LEDs 26 and 27.

The trigger logic 110 may perform a plurality of functions. As an example, the trigger logic 110 may control the generation of the trigger pulse required to start and stop the recording of the camera. The trigger logic 110 initiates a trigger pulse of the pulse rate required by the particular camera used.

The display unit 111 indicates the status of the camera assembly 10. The display unit 111 may consist of the green LED 27 and the yellow LED 26, as discussed above.

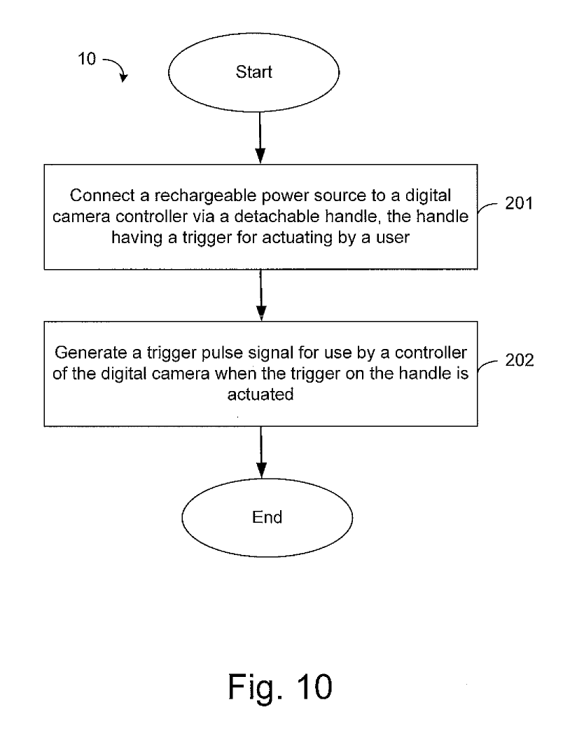

FIG. 10 is a flowchart depicting exemplary architecture and functionality of a camera assembly 10 (FIG. 1) of the present disclosure. Referring to step 201 of FIG. 10, a power source (e.g., battery 14) is connected to the digital camera controller 71 via the handle 13, the handle 13 having the trigger 15 for actuating by a user. Referring to step 202, a trigger pulse signal is generated for use by the digital camera controller 71 when the trigger 15 on the handle 13 is actuated.

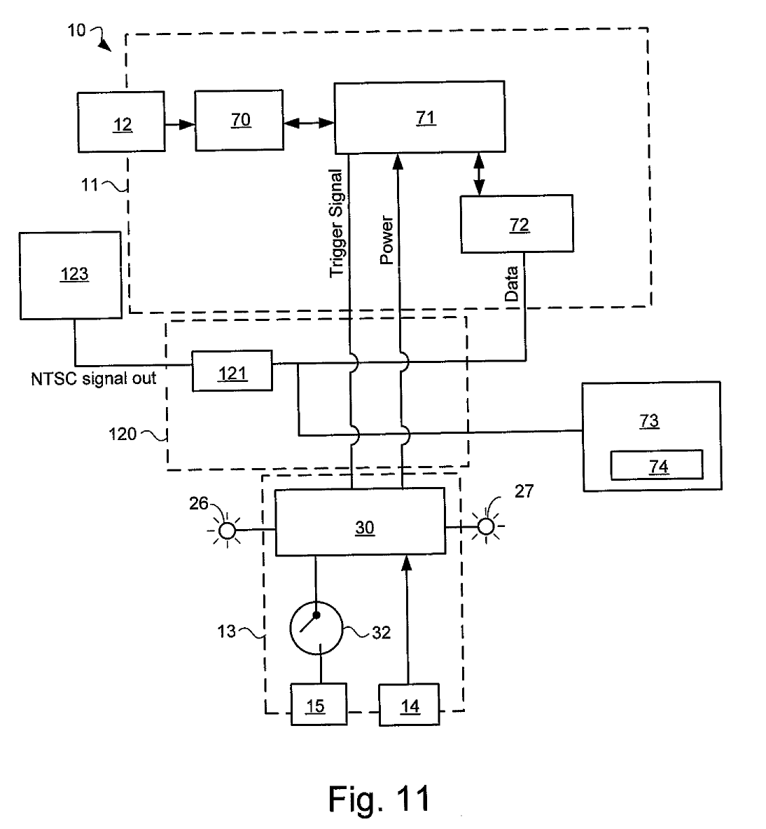

FIG. 11 illustrates in block diagram form an alternative embodiment of the camera assembly 10, wherein an adapter 120 is disposed between the handle 13 and the camera housing 11. The adapter 120 samples (without destroying) the data signal (not shown) received from the camera controller 71 through the digital interface 72 and converts it into a National Television System Committee (NTSC) signal via an A/D converter 121. The adapter also passes the original digital data signal back out of the adapter to the remote host 73. The NTSC signal (not shown) is then transmitted to a display monitor 123 that may be installed on top of the camera housing 11 in lieu of the viewfinder 17 (FIG. 1). The purpose of the adapter 120 in this configuration is thus to split the data transmitted from the camera controller 71 for use by both the display monitor 123, and the host computer. The adapter 120 could also or alternatively house a wireless interface (not shown) so that a wired connection to the remote host computer 73 is not required. In another embodiment of the camera assembly 10, the adapter 120 might also intercept the power signal from the power controller 30 and split it out to provide power to a light or lights (not shown) mounted on the camera to illuminate the event of interest.

This invention may be provided in other specific forms and embodiments without departing from the essential characteristics as described herein. The embodiments described are to be considered in all aspects as illustrative only and not restrictive in any manner.

As described above and shown in the associated drawings and exhibits, the present invention comprises a portable high speed digital camera. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A portable handheld camera system comprising:
a camera with a housing;
a handle coupled to the camera housing, the handle comprising
a grip portion comprising a trigger switch, and
a bottom concavity;
a battery detachably coupled to the handle comprising a rechargeable power source for providing electrical power to the camera, the battery being receivable by the bottom concavity of the handle.

2. The camera system of claim 1, wherein the handle connects to a lower side of the camera housing and the handle further comprises a thumb wheel connected to a screw, wherein turning the thumb wheel rotates the screw to detach the camera housing from the handle.

3. The camera system of claim 1, wherein depressing the trigger switch causes the camera to begin recording, and releasing the trigger switch causes the camera to stop recording.

4. The camera system of claim 1, wherein depressing the trigger switch causes the camera to stop recording, and releasing the trigger switch causes the camera to start recording.

5. The camera system of claim 1, further comprising a means for filtering power received from the rechargeable power source and delivering the filtered power to the camera.

6. The camera system of claim 1, wherein the camera may be supported and operated with one hand.

7. A portable high speed camera system comprising:
a high speed digital camera with a housing;
a handle coupled to the camera housing for supporting the camera in an upright position,
the handle comprising
a grip portion comprising a trigger switch, and
a flared base portion comprising a bottom concavity;
a battery detachably received by the bottom concavity, wherein the battery comprises a rechargeable power source for providing electrical power to the camera, and wherein the battery has a threaded mounting hole for receiving a tripod.

8. A camera, comprising:
a detachable handle having a portion for receiving a battery;
a trigger positioned on the handle for activating the digital camera; and
logic configured to provide a trigger signal to a controller of the camera to start the camera recording when a user grasps the handle and actuates the trigger.

9. The camera of claim 8, wherein the portion for receiving the battery is a concave lower portion of the handle.

10. The camera of claim 8, wherein the handle is elongated and substantially perpendicular to a camera housing, the housing comprising a lens, an image sensor, and the controller.

11. The camera of claim 8, wherein the handle further comprises a rotatable screw for insertion into an opening in the camera housing.

12. The camera of claim 11, wherein the camera housing further comprises a threaded opening for receiving the rotatable screw.

13. The camera of claim 11, wherein the handle further comprises an exposed wheel coupled to the rotatable screw such that when a user actuates the wheel, the screw rotates and detachably couples the handle to the housing.

14. The camera of claim 8, wherein the logic is further configured to configured to provide a trigger signal to a controller of the camera to stop the camera recording when a user releases the trigger.

15. The camera of claim 8, wherein the handle has a slightly concave portion for receiving a user's fingers.

16. The camera of claim 15, wherein the trigger is positioned on the slightly concave portion.

17. A digital camera method, comprising the steps of:
connecting a power source to a digital camera controller via a detachable handle, the handle having a trigger for actuating by a user; and
generating a trigger pulse signal for use by a controller of the digital camera when the trigger on the handle is actuated.

18. The digital camera method of claim 17, wherein the connecting the power source step further comprises the step of inserting a battery holder into a concave lower portion of the handle.

19. The digital camera method of claim 17, wherein the handle is elongated and substantially perpendicular to a housing, the housing comprising a lens, an image sensor, and the controller, further comprising the step of inserting a rotatable screw into an opening in the housing.

20. The digital camera method of claim 19, wherein the opening is threaded for receiving the rotatable screw, further comprising the step of actuating an exposed wheel coupled to the rotatable screw to detachably secure the handle to the housing.

21. The digital camera method of claim 17, further comprising transmitting the trigger pulse signal to the controller.

22. The digital camera method of claim 17, wherein when the trigger on the handle is depressed, the controller activates a lens and an image sensor for capturing digital image data.

23. The digital camera method of claim 18, wherein when the trigger on the handle is released, the controller deactivates the lens and the image sensor.

24. A digital camera, comprising:
a handle having a portion for receiving a battery holder, the battery holder coupled to a power source;
a trigger positioned on the handle for activating the digital camera;
means for converting power received from a power source contained in the battery holder to power useable by a controller of the digital camera;
means for generating a trigger pulse signal when a user grasps the handle and actuates the trigger.

25. The digital camera of claim 24, further comprising means for transmitting the trigger pulse signal to the controller to start the camera recording.
